(19) United States
(12) Patent Application Publication
(10) Pub. No.: US 2019/0182029 A1
(43) Pub. Date: Jun. 13, 2019

(54) METHOD OF GENERATING BLOCK CHAIN AND APPARATUS AND METHOD FOR GENERATING BLOCKS

(71) Applicant: ELECTRONICS AND TELECOMMUNICATIONS RESEARCH INSTITUTE, Daejeon (KR)

(72) Inventors: Jong Choul YIM, Daejeon (KR); Sun Me KIM, Daejeon (KR); Ji Young KWAK, Gwangju (KR); Hyun Kyung YOO, Daejeon (KR); Thai Quang Tung, Daejeon (KR)

(73) Assignee: ELECTRONICS AND TELECOMMUNICATIONS RESEARCH INSTITUTE, Daejeon (KR)

(21) Appl. No.: 16/139,924

(22) Filed: Sep. 24, 2018

(30) Foreign Application Priority Data
Dec. 8, 2017 (KR) 10-2017-0168032

(51) Int. Cl. H04L 9/06; G06F 17/30; H04L 9/30; H04L 29/06

(52) U.S. Cl. CPC H04L 9/0637; H04L 9/0643; H04L 2209/38; H04L 9/30; H04L 63/08; G06F 17/30283

(57) ABSTRACT

Provided are a method of generating a block chain and an apparatus and method for generating a block. The method of generating a block performed by a node in a block chain network includes receiving a first block from a first node, connecting the received first block to a block chain, determining whether the current node is qualified to generate a second block, which has the first block connected to the block chain as a parent block, generating a second block when the current node is qualified to generate a second block, and transmitting the generated second block to nodes other than the current node. Therefore, it is possible to prevent the waste of energy caused by all nodes performing proof of work for block generation.

### CLAIM FOR PRIORITY

This application claims priority to Korean Patent Application No. 2017-0168032 filed on Dec. 8, 2017 in the Korean Intellectual Property Office (KIPO), the entire contents of which are hereby incorporated by reference.

### BACKGROUND

### 1. Technical Field

Example embodiments of the present invention relate to a method of generating a block chain and an apparatus and method for generating a block, and more specifically, to a technology for preventing unnecessary energy waste by qualifying only some of numerous nodes constituting a block chain system to generate blocks and connecting a block generated by a qualified node to a block chain.

### 2. Related Art

Fundamentally, a block chain system may be referred to as a distributed ledger system in which numerous nodes are connected in a peer-to-peer (P2P) network and process transactions. Each node in the P2P network verifies the validity of a transaction received from a client or another node, propagates again the transaction whose validity has been verified to other nodes, and generates a block by collecting transactions. A block generated in this way is required to refer to a previous block (this is referred to as a parent block), and thus blocks are connected like a chain. By tracking transactions in the blocks along the chain, it is possible to identify an order in which the transactions have occurred. Therefore, a transaction in a parent block may have occurred earlier than a transaction in a child block.

Meanwhile, since a kind of incentive is given to a node which has generated a block, numerous nodes competitively try to generate a block. For example, in the case of Bitcoin, when a node generates a block, a right to issue a certain amount of digital currency is given to the node.

In general, a process in which each node tries to generate a block is referred to as mining. If each node is allowed to generate a block simply by collecting transactions without any effort, numerous blocks may be simultaneously generated, and blocks may include many duplicate transactions or have different parents. Therefore, it will be very difficult to sequentially record transactions from a consistent viewpoint.

To prevent this, a block chain system provides an opportunity of generating a block to all nodes but requires each node to perform a kind of work and prove that the node has performed the work, which is referred to as proof of work. In other words, a block chain system adjusts a period in which a block is generated through proof of work, thereby preventing a malicious node from generating blocks at random without any cost.

However, the block generation method based on proof of work forces each node to perform numerous calculations in order to competitively generate valid blocks and allows only one of a plurality of generated blocks to be finally accepted as a valid block. Therefore, numerous nodes waste energy (electricity) which has been consumed for calculation. Also, transaction processing performance is related to a block generation period and thus is limited.

### SUMMARY

Accordingly, example embodiments of the present invention are provided to substantially obviate one or more problems due to limitations and disadvantages of the related art.

Example embodiments of the present invention provide a method of generating a block chain performed by a node in a block chain network.

The method of generating a block chain may comprise receiving a first block from a first node, verifying validity of the received first block and connecting the first block whose validity has been verified to a block chain.

The verifying of validity of the first block may comprise verifying whether the first node is qualified to generate the first block by referring to a header of the first block.

The header of the first block may include a field indicating at least one of a version of a protocol, a hash value of a header of a parent block, a Merkle root, a time at which the first block has been generated, the degree of difficulty, a nonce value, a node identifier of a node which has generated the first block, proof of the node identifier, and a group count.

The verifying of validity of the first block may comprise verifying validity of each field value included in the header of the first block.

The verifying of whether the first node may be qualified to generate the first block comprises comparing a block turn value determined according to a height of the block chain and a node turn value determined using the node identifier.

The block turn value may be a remainder of dividing the height of the block chain by the group count.

The node turn value may be a remainder obtained by calculating a hash function of the sum of the hash value of the header of the parent block and the node identifier and dividing a result value of the hash function by the group count.

The verifying of validity of the first block may comprise verifying validity of the group count.

The verifying of validity of the group count may comprise receiving information of individual nodes according to a communication protocol for identifying the total number of nodes, determining the total number of nodes by accumulating the received information of the individual nodes and determining a group count using the total number of nodes and comparing the determined group count with the group count included in the header of the first block.

The proof of the node identifier may be an electronic signature for the node identifier.

The verifying of validity of the first block may comprise verifying validity of the node identifier using the proof of the node identifier.

The verifying of validity of the first block may comprise verifying validity of the first block using Intel software guard extensions (SGX).

Example embodiments of the present invention also provide a method of generating a block performed by a node in a block chain network.

The method of generating a block may comprise receiving a first block from a first node, connecting the received first block to a block chain, determining whether the current node is qualified to generate a second block, which has the first block connected to the block chain as a parent block, generating a second block when the current node is qualified to generate a second block and transmitting the generated second block to nodes other than the current node.

The determining of whether the current node may be qualified to generate a second block comprises comparing a block turn value determined according to a height of the block chain and a node turn value determined using an identifier of the current node.

The block turn value may be a remainder of dividing the height of the block chain by a group count.

The node turn value may be a remainder obtained by calculating a hash function of the sum of a hash value of a header of the first block and the identifier of the current node and dividing a result value of the hash function by a group count.

The group count may be acquired by determining the total number of nodes in the block chain network and dividing the determined total number of nodes by a preset group size.

The total number of nodes may be determined by receiving information of individual nodes according to a communication protocol for identifying the total number of nodes and accumulating the received information of the individual nodes.

The generating of the second block may comprise generating a header of the second block including a field indicating at least one of the identifier of the current node, a group count, and proof of the identifier of the current node.

The identifier of the current node may be a public key issued from an authentication server.

Example embodiments of the present invention also provide an apparatus for generating a block in a block chain network.

The apparatus for generating a block in a block chain network may include at least one processor and a memory configured to store instructions for directing the at least one processor to perform at least one operation.

The at least one operation may comprise receiving a first block from a first node, connecting the received first block to a block chain, determining whether a current node is qualified to generate a second block, which has the first block connected to the block chain as a parent block, generating a second block when the current node is qualified to generate a second block and transmitting the generated second block to nodes other than the current node.

### BRIEF DESCRIPTION OF DRAWINGS

Example embodiments of the present invention will become more apparent by describing in detail example embodiments of the present invention with reference to the accompanying drawings, in which:

FIG. 1 is a set of example diagrams illustrating nodes which are qualified to perform mining in a block chain network according to an example embodiment of the present invention;

FIG. 2 is an example diagram illustrating a method of giving a qualification for mining depending on block height according to an example embodiment of the present invention;

FIG. 3 is a flowchart of a method in which a node of a block chain network connects a block to a block chain and generates a new block according to an example embodiment of the present invention;

FIG. 4 is an example diagram of a method of managing a node identifier through an authentication server according to an example embodiment of the present invention;

FIG. 5 is an example diagram of a method of managing a node identifier through Intel software guard extensions (SGX) according to an example embodiment of the present invention;

FIG. 6 is an example diagram illustrating a network protocol for identifying the total number of nodes in a block chain network according to an example embodiment of the present invention;

FIG. 7 is a flowchart illustrating a method of implementing a network protocol according to an example embodiment of the present invention; and

FIG. 8 is a diagram showing a configuration of an apparatus for generating a block in a block chain network according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing the example embodiments of the present invention, however, the example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms ““a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

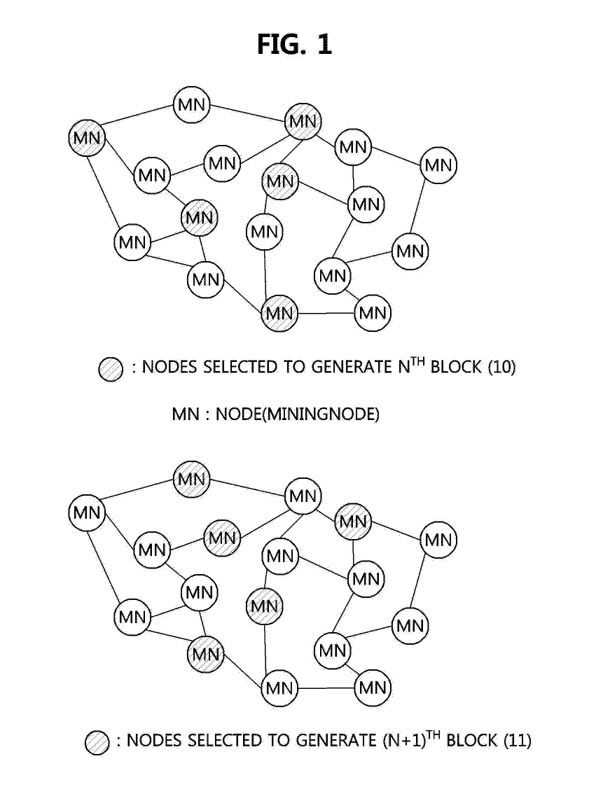

FIG. 1 is a set of example diagrams illustrating nodes which are qualified to perform mining in a block chain network according to an example embodiment of the present invention.

Referring to FIG. 1, it is possible to see that a block chain network according to an example embodiment of the present invention has a structure in which a plurality of nodes MN are connected to each other via a peer-to-peer (P2P) network.

Here, the nodes (referred to as mining nodes) MN in the block chain network may serve to verify the validity of a transaction and propagate the transaction to other nodes and also serve to collect transactions and generate a block.

Each node may perform proof of work to generate a valid block. For example, it is possible to generate a valid block by generating a hash value which satisfies a condition. Specifically, a node may be recognized to have generated a valid block only when a hash value of a header (or a value obtained by performing one-way encryption on the header) of a generated block is less than a predetermined specific value. Since transactions and a parent block included upon generation of the block may be considered to be fixed, each node may perform a calculation of identifying a hash value which satisfies the condition while continuously changing a nonce value (a random value) included in the header. Therefore, a node having more computing power with which it is likely to rapidly calculate a hash value is highly likely to mine a block. In general, computing power of each node used for hash calculation is referred to as hashing power. In other words, when a node has high hashing power, the node is highly likely to generate a valid block. Although a block generation period is adjusted through proof of work, several valid blocks may be generated at similar times. In this case, one of the valid blocks is finally determined as a winner according to a block selection policy. According to a representative method, a block which belongs to the longest chain is selected as a winner.

Like this, when several blocks which satisfy the requirement of proof of work are generated, only one of the blocks is valid, and all computation efforts and energy of other nodes having generated blocks may be discarded. In the present invention, this problem may be solved by a method of qualifying only some specific nodes to generate blocks.

Referring back to FIG. 1, the upper network of FIG. 1 is a block chain network corresponding to a case of generating arbitrary N^{th} blocks. In this case, only first nodes 10 which are selected from among nodes in the block chain network may generate N^{th} blocks for proof of work. Next, the lower network of FIG. 1 is the block chain network corresponding to a case of generating arbitrary (N+1)^{th} blocks. In this case, second nodes 11 which are newly selected from among the total nodes in the block chain network may be qualified to generate (N+1)^{th} blocks. Here, the first nodes 10 and the second nodes 11 may partially overlap or may be totally different.

In other words, only a group composed of nodes selected from among total nodes may be allowed to generate a block, and such a qualification for block generation may be given to a group of nodes which are newly selected every time a block is generated.

It will be described below what kind of node may be qualified to generate a block.

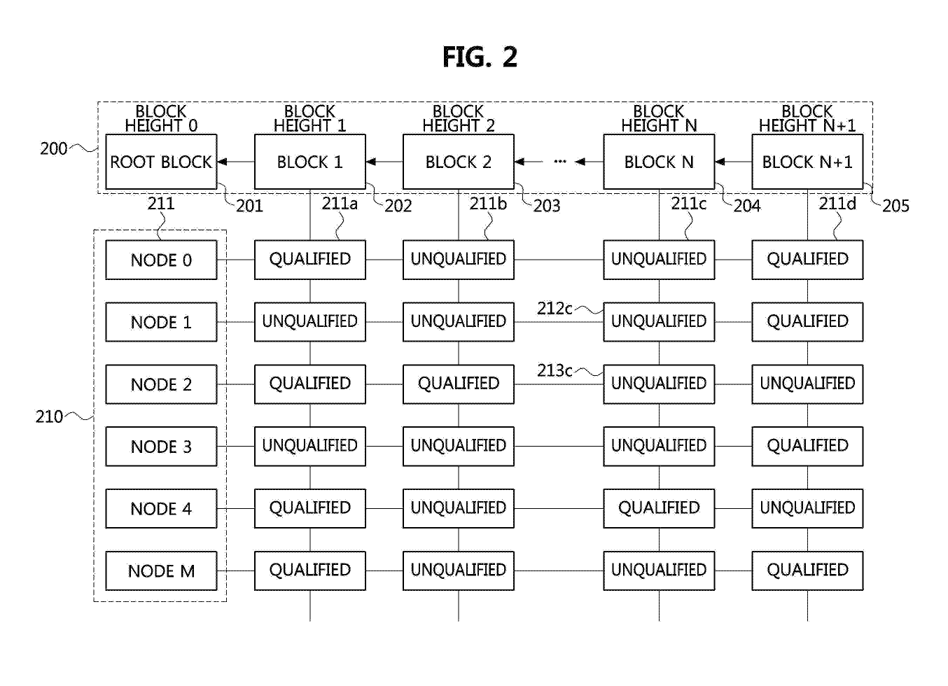

FIG. 2 is an example diagram illustrating a method of giving a qualification for block generation depending on block height according to an example embodiment of the present invention.

Referring to FIG. 2, blocks generated by respective nodes are connected to each other on the basis of a root block 201 (also referred to as a genesis block) to constitute a chain 200. The block chain 200 may be formed when each block refers to its parent block.

Here, when respective blocks are connected to each other on the basis of the root block 201, heights thereof may increase. Therefore, each block may be considered to have a height on the basis of the root block 201, and the total number of blocks connected to the block chain 200 may be considered as a height of the block chain 200. For example, block 1 202 has a block height of 1 as a child block of the root block 201, and block n+1 205 has a block height of n+1 as a child block of block n 204 and an (N+1)^{th} block from the root block 201. When a block is additionally connected to the block chain 200, the height of the block chain 200 may continuously increase in this way.

Meanwhile, nodes 210 which generate (or mine) blocks may be qualified to generate only blocks of specific heights. For example, node 0 211 may be qualified to generate block 1 202 corresponding to a block height of 1 (211a), may not be qualified to generate block 2 203 corresponding to a block height of 2 (211b), may not be qualified to generate block n 204 corresponding to a block height of n (211c), and may be qualified to generate block n+1 205 corresponding to a block height of n+1 (211d).

Also, individual node qualification for block generation may be described from the viewpoint of a block. For example, with respect to block n 204 corresponding to a block height of n, node 0 211 may not be qualified for block generation (211c), node 1 may not be qualified for block generation (212c), and node 2 may not be qualified for block generation (213c).

Therefore, the nodes 210 which generate blocks may be qualified for block generation depending on block height.

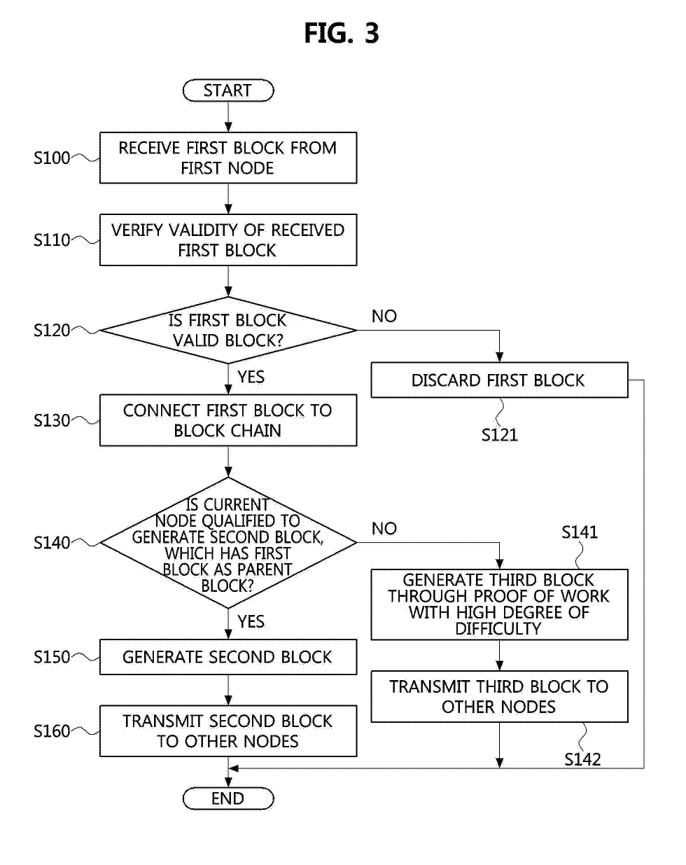

FIG. 3 is a flowchart of a method in which a node of a block chain network connects a block to a block chain and generates a new block according to an example embodiment of the present invention.

Referring to FIG. 3, a method, which is performed by a node in a block chain network, of connecting a block to a block chain and generating a new block may include an operation of receiving a first block from a first node (S100), an operation of verifying the validity of the received first block (S110), an operation of connecting the first block to a block chain (S130) when the first block is a valid block (S120), an operation of determining whether the current node is qualified to generate a second block which has the first block connected to the block chain as a parent block (S140), an operation of generating a second block (S150) when the current node is qualified to generate a second block, and an operation of transmitting the generated second block to nodes other than the current node (S160).

The operation (S110) of verifying the validity of the first block may include an operation of verifying whether transactions included in the first block are valid.

The operation (S110) of verifying the validity of the first block may include an operation of verifying whether the first node is qualified to generate the first block by referring to a header of the first block. It may be determined whether the first node is qualified to generate the first block according to a height of the first block, which may be understood with reference to the term “block turn” described below.

Here, the header of the first block may include a field indicating at least one of a version of a protocol, a hash value of a header of a parent block, a Merkle root, a time at which the block has been generated, the degree of difficulty, a nonce value, a node identifier of a node which has generated the block, proof of the node identifier, and a group count.

The group count may be a parameter which represents how many groups total nodes of the block chain network according to an example embodiment of the present invention will be divided into. For example, when the group count is 1, the total nodes may be qualified to generate blocks. When the group count is 2, only half of the total nodes may be qualified to generate blocks. When the group count is n, 1/n of the total nodes may be qualified to generate blocks. As the group count, a preset value or a dynamically changing value may be used.

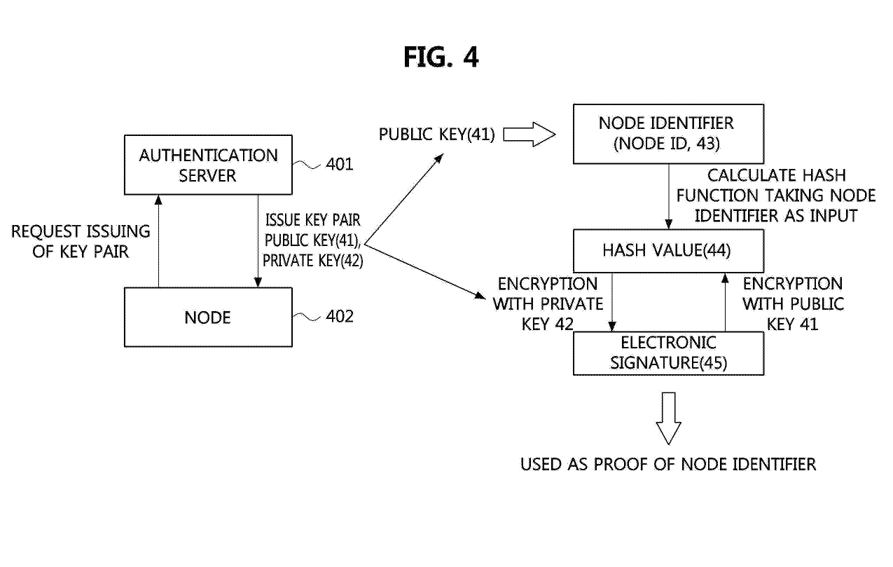

The node identifier is a unique identification code given to the node which has generated the corresponding block and may use one of a public key of FIG. 4, an Internet protocol (IP) address of the node, and an identifier which is randomly generated.

The operation (S110) of verifying the validity of the first block may include an operation of verifying whether the first node is qualified to generate the first block by referring to at least one of the group count, the node identifier, and the hash value of the header of the parent block

Specifically, the operation of verifying whether the first node is qualified to generate the first block may include an operation of comparing a block turn value determined according to a current height of the block and a node turn value determined using the node identifier. When a comparison result indicates that the two values are identical, it is possible to determine that the first node is qualified to generate the first block.

The block turn value may be a parameter for determining which group may generate a first block, and a remainder of dividing a height of the block chain by the group count may be used as the block turn value. In other words, block turn may be expressed by Equation 1 below, and mod may be an operator for calculating a remainder. Here, it is possible to know the group count by referring to the header of the first block. Also, the height of the block chain may be a height of the block chain not including a new block to be generated.

Block turn=Height of block chain mod Group count [Equation 1]

Meanwhile, the node turn value may be a remainder obtained by calculating a hash function of the sum of the hash value of the header of the parent block and the node identifier and dividing a result value of the hash function by the group count. In other words, node turn may be expressed by Equation 2 below.

Node turn=hash(Hash value of header of parent block+Node identifier) mod Group count [Equation 2]

Since parameters used to verify the validity of the first block refer to fields included in the header of the first block, a process of verifying the validity of field values included in the header of the first block may be required. Therefore, the operation (S110) of verifying the validity of the first block may include an operation of verifying the validity of each field value included in the header of the first block.

To verify the validity of the group count, the current node may calculate a group count by itself, and when the calculated group count equals the group count included in the header of the first block, it is possible to determine that the group count is valid. Therefore, an operation of verifying the validity of the group count may include an operation of receiving information of individual nodes according to a communication protocol for identifying the total number of nodes, an operation of determining the total number of nodes by accumulating the received information of individual nodes, and an operation of determining the group count using the total number of nodes and comparing the determined group count and the group count included in the header of the first block. Here, the group count may be calculated by determining the total number of nodes and a size of groups and dividing the total number of nodes by the size of groups. A detailed process thereof will be described below with reference to FIG. 6.

After the operation (S110) of verifying the validity of the first block or the operation (S130) of connecting the first block to the block chain, if the current node is generating a block having the same height as the first block, an operation of stopping the generation of the block may be further included.

The method of connecting a block to a block chain and generating a new block may include an operation of discarding the first block (S121) when the first block is not a valid block (S120).

The method of connecting a block to a block chain and generating a new block may include an operation of being on standby without generating a second block until another block is received when the current node is not qualified to generate a second block which has the first block as a parent block.

In this case, the current node may generate a third block through proof of work with a high degree of difficulty in addition to standing by until another block is received (S141) and may transmit the generated third block to another node (S142). In other words, although the current node is not qualified to generate a second block, when the current node performs proof of work with a high degree of difficulty, the current node may be qualified to generate a block. Here, a third block may be identical to or different from a second block.

The operation (S140) of determining whether the current node is qualified to generate a second block may be performed in the same way as the operation of determining whether the first node is qualified to generate the first block. In other words, whether the current node is qualified to generate a second block may be determined by comparing a block turn value determined according to the height of the block chain and the node turn value determined using the node identifier. As described above, the block turn value may be a remainder of dividing a current height of the block chain by the group count, and the node turn value may be a remainder obtained by calculating a hash function of the sum of a hash value of the first block, which is the parent block of the second block, and the node identifier of the current block and dividing the hash function value by the group count. In other words, it is necessary to reset the node identifier and the hash value of the parent block in Equation 2. Therefore, the same description will not be reiterated.

Meanwhile, the proof of the node identifier may be an electronic signature for the node identifier. The operation (S110) of verifying whether the first node is qualified to generate the first block may include an operation of verifying the validity of the node identifier using the proof of the node identifier.

Also, the operation (S110) of verifying whether the first node is qualified to generate the first block may include verifying the validity of the first block using Intel software guard extensions (SGX).

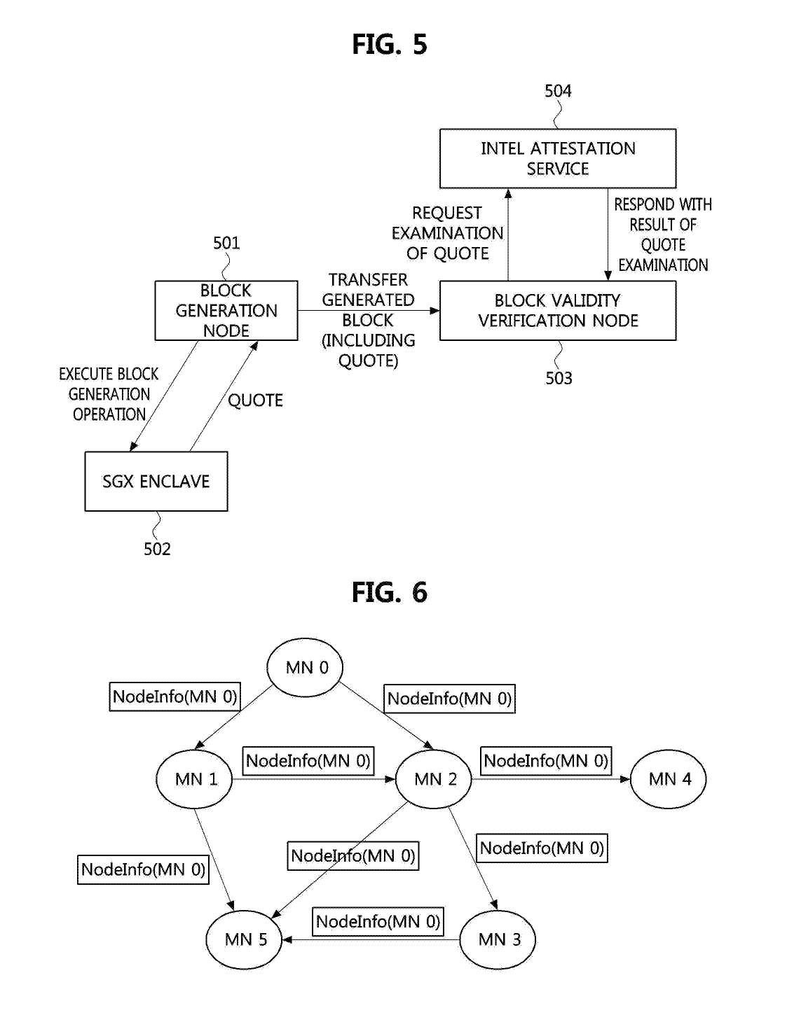

Here, the operation of verifying the validity of the node identifier will be described below with reference to FIG. 4, and a method of using Intel SGX will be described below with reference to FIG. 5.

Meanwhile, as a part of the process of FIG. 3, a block chain generation method performed by a node, which verifies the validity of a block received from another node and connects the verified block to a block chain, in a block chain network may include an operation of receiving a first block from a first node, an operation of verifying the validity of the received first block, and an operation of connecting the first block whose validity has been verified to a block chain.

Also, a block generation method performed by a node in a block chain network may include an operation of receiving a first block from a first node, an operation of connecting the received first block to a block chain, an operation of determining whether a current node is qualified to generate a second block which has the first block connected to the block chain as a parent block, an operation of generating a second block when the current node is qualified to generate a second block, and an operation of transmitting the generated second block to nodes other than the current node.

The operation of determining whether the current node is qualified to generate a second block may include an operation of comparing a block turn value determined according to the height of the block chain and a node turn value determined using an identifier of the current node.

The group count for calculating block turn and node turn may be acquired by determining the total number of nodes in the block chain and dividing the determined total number of nodes by a preset group size.

The total number of nodes may be determined by receiving information of individual nodes according to a communication protocol for identifying the total number of nodes and accumulating the received information of individual nodes.

The operation of generating a second block may include an operation of generating a header of a second block including a field indicating at least one of the identifier of the current node, the group count, and proof of the identifier of the current node.

The identifier of the current node may be a public key issued from an authentication server. A public key issuing process of an authentication server will be described below with reference to FIG. 4.

In addition to this, elements of the flowchart of FIG. 3 may be included in the method of generating a block or the method of generating a block chain, and detailed descriptions thereof will not be reiterated.

FIG. 4 is an example diagram of a method of managing a node identifier through an authentication server according to an example embodiment of the present invention.

Referring to FIG. 4, an authentication server 401 may be used as a means for managing a node identifier 43 included in a header of a block. For example, when a node 402 in a block chain network requests registration with the authentication server 401, the authentication server 401 may register the node 402 and issue a key pair consisting of a public key 41 and a private key 42 to the node 402.

Therefore, when generating a block, the node 402 in the block chain network may use the issued public key 41 as the node identifier 43 included in a header of the block and use an electronic signature 45 as proof of the node identifier 43 included in the header of the block. Here, the electronic signature 45 may be a value acquired by calculating a hash value 44 with a hash function using the node identifier 43 as an input and encrypting the hash value 44 with the issued private key 42. The encryption algorithm SHA-256 may be used as the hash function. However, this is a mere example, and it is possible to apply any one-way encryption algorithm.

Meanwhile, when the public key 41 is used as the node identifier 43 and the electronic signature 45 is used as proof of the node identifier 43 through the authentication server 401, a process of verifying the validity of the generated block may include a process of verifying the node identifier 43. A method of verifying the node identifier 43 is as follows.

It is possible to verify the node identifier 43 using the proof (i.e., the electronic signature 45) of the node identifier 43 included in the header of the block. Specifically, it is determined whether a result value obtained by decrypting the electronic signature 45 with the node identifier 43 coincides with the hash value 44 obtained by using the hash function with the node identifier 43 as an input, so that the node identifier 43 may be verified. When the two values coincide with each other, it is possible to determine that the node identifier 43 is valid.

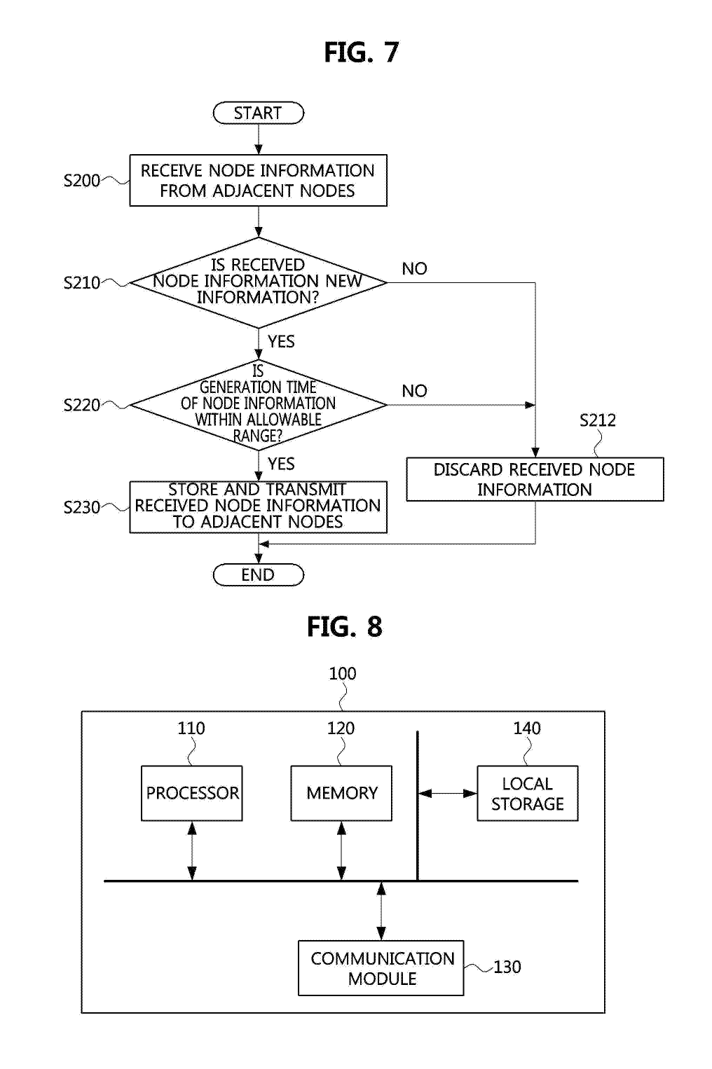

When an IP address or a randomly generated identifier is used as the node identifier 43, the node identifier 43 may be verified using a node information table (Table 1) of each node, which is generated in the process of FIG. 7, according to whether the corresponding node identifier information is in the table. When the corresponding node identifier information is in the node information table, the node identifier 43 may be determined to be valid.

FIG. 5 is an example diagram of a method of managing a node identifier through Intel SGX according to an example embodiment of the present invention.

Intel SGX is a central processing unit (CPU)-based technology for improving application security and corresponds to architecture extensions designed to enhance the security of software through an “inverse sandbox” mechanism. In other words, SGX may denote an extended instruction set that provides a hardware sandbox to protect a system from malware.

Referring to FIG. 5, when a block generation node 501 which generates a block executes a program operation of generating a block (or a header of a block) in an SGX enclave 502, it is possible to obtain a quote as proof of execution. The obtained quote may be used as proof of a node identifier, and a public key used to generate the SGX enclave 502 may be used as the node identifier.

When execution of a block generation operation, a node identifier, and proof of the node identifier are determined through SGX, a block generated on the basis thereof may be transferred to another node (a block validity verification node) 503 and subjected to a process of verifying the validity of the block. The process of verifying the validity of the block is as follows.

First, the block validity verification node 503 requests an Intel attestation service 504 to examine proof of the node identifier included in the header of the block. When a response indicating that a result of examining the proof of the node identifier is successful is received from the Intel attestation service 504, the block validity verification node 503 may determine that the block received from the block generation node 501 is valid.

FIG. 6 is an example diagram illustrating a network protocol for identifying the total number of nodes in a block chain network according to an example embodiment of the present invention.

As described above with reference to FIG. 3, it is necessary to identify a group count in order not only to determine block turn and node turn according to Equations 1 and 2 but also to verify the group count included in the header of the received block. A preset value may be used as the group count, or the group count may be acquired by receiving the total number of nodes from an external server, which has identified the total number of nodes, and dividing the total number of nodes by a group size. Specifically, when the external server provides a function for transferring the total number of nodes, it is possible to acquire the total number of nodes by periodically calling the provided function. Here, a preset value may be used as the group size. When a result of dividing the total number of nodes by the group size is not a natural number, it is possible to determine the group count by rounding up or down the result (or adding 1 to the result).

Also, the group count may be calculated using the node identifier. For example, the total number of nodes may be obtained by collecting node identifiers included in the block header and identifying the number of different values among the collected node identifiers. In this case, the total number of nodes may be determined by multiplying the identified number of different values by a proportional constant. This is a method of inferring the total number of nodes by multiplying the identified number of different values by a proportional constant because the number of nodes which have succeeded in generating blocks is smaller than the total number of nodes.

Further, a network protocol for identifying the total number of nodes may be used to determine the total number of nodes, and the group count may be acquired by dividing the determined total number of nodes by the group size. A specific operation process of the network protocol for identifying the total number of nodes may be performed so that all nodes in a block chain network may generate packets containing their node information NodeInfo and propagate the node information to other nodes adjacent thereto.

Referring to FIG. 6, it is possible to see a process in which node 0 (MN 0) propagates its node information (NodeInfo(MN 0)). First, node 0 may transmit its node information (NodeInfo(MN 0)) to node 1 (MN 1) and node 2 (MN 2) which are adjacent thereto. Node 1 may transfer the received node information (NodeInfo(MN 0)) of node 0 to node 2 (MN 2) and node 5 (MN 5) which are adjacent thereto. Therefore, nodes in a network may transfer their node information to adjacent nodes and may store, when node information is received from other nodes, the received node information and then propagate the received node information to other adjacent nodes.

Looking at node 5 (MN 5) in FIG. 6, it is possible to see that the node information (NodeInfo(MN 0)) of node 0 (MN 0) is received from all of node 1 (MN 1), node 2 (MN 2), and node 3 (MN 3). In this case, the node information which is received for the first time may be stored, and the node information which is received thereafter may be discarded.

FIG. 7 is a flowchart illustrating a method of implementing a network protocol according to an example embodiment of the present invention.

Referring to FIG. 7, a process of implementing a network protocol according to FIG. 6 is illustrated in further detail.

First, node information may be received from an adjacent node (S200). The node information may include at least one of a time (a timestamp) at which the node information has been generated, an IP address of a node, a random node identifier, and a block chain height at the time at which the node information has been generated.

Next, it may be determined whether the received node information is new information (S210), and the received node information may be discarded (S212) when the received node information is not new information. When the received node information is new information, it may be determined whether the generation time of the node information is within an allowable range (S220). When the generation time is out of the allowable range, the received node information may be discarded (S212).

On the contrary, when the generation time is within the allowable range, the received node information may be stored and transmitted to other adjacent nodes (S230).

Meanwhile, when received node information is continuously accumulated, each node may create a node information table containing information on total nodes as shown in Table 1 below.

TABLE 1

| IP | | Transmission | Random node |
|---|---|---|---|
| address | Generation time | time | identifier |
| 10.10.10.1 | 2017.10.10 | 2017.10.10 | Fx982fs |
| | 13:50:05 | 13:51:05 | |
| 10.10.10.2 | 2017.10.10 | 2017.10.10 | Shjf82m |
| | 13:50:55 | 13:51:10 | |
| . . . | . . . | . . . | . . . |

Referring to Table 1 above, it is possible to store an IP address of a node and a generation time included in received node information together with a transmission time at which the received node information is transmitted to adjacent nodes and a random node identifier.

Meanwhile, as described above, received node information includes a block chain height corresponding to a time at which the node information has been generated, and all the pieces of node information of Table 1 may be separately configured depending on block chain height. For example, all the pieces of node information may be configured for a case of a block chain height being 1000 and a case of a block chain height being 2000.

To configure all the pieces of node information depending on block chain height, each node may transmit its node information to other adjacent nodes every time a block chain height is changed by a preset value. For example, each node may transmit its node information every time a block chain height is changed by 1000.

FIG. 8 is a diagram showing a configuration of an apparatus for generating a block in a block chain network according to an example embodiment of the present invention.

An apparatus 100 for generating a block in a block chain network may include at least one processor 110 and a memory 120 configured to store instructions for directing the at least one processor 110 to perform at least one operation.

Also, the apparatus 100 for generating a block may include a communication module 130 configured to perform P2P communication with other nodes in the block chain network.

Further, the apparatus 100 for generating a block may include a local storage 140 configured to receive node information from other nodes and store the received node information.

The at least one operation may include an operation of receiving a first block from a first node, an operation of connecting the received first block to a block chain, an operation of determining whether a current node is qualified to generate a second block which has the first block connected to the block chain as a parent block, an operation of generating a second block when the current node is qualified to generate a second block, and an operation of transmitting the generated second block to nodes other than the current node.

The apparatus 100 for generating a block may correspond to one of the above-described nodes in the block chain network and may be, for example, a desktop computer, a laptop computer, a smart phone, a tablet personal computer (PC), a mobile phone, a smart watch, smart glasses, an e-book reader, a portable multimedia player (PMP), a portable game machine, a navigation device, a digital camera, a digital multimedia broadcasting (DMB) player, a digital audio recorder, a digital audio player, a digital video recorder, a digital video player, a personal digital assistant (PDA), etc. which are capable of communication.

Other operations of the apparatus 100 for generating a block may include processes according to the above-described method of generating a block and the descriptions of FIGS. 1 to 7, and detailed descriptions thereof will not be reiterated.

With the method of generating a block performed by a node in a block chain network, the apparatus for generating a block, and the method of generating a block chain according to the above-described example embodiments of the present invention, only some of the total nodes are allowed to participate in proof of work for block generation, and thus it is possible to reduce a huge waste of electrical energy which is caused when the total nodes perform proof of work for block generation.

Also, a block generation period is shortened, and thus transaction processing performance is improved.

While the example embodiments of the present invention and their advantages have been described in detail, it should be understood that various changes, substitutions and alterations may be made herein without departing from the scope of the invention.

What is claimed is:

1. A method of generating a block chain performed by a node in a block chain network, the method comprising:
receiving a first block from a first node;
verifying validity of the received first block; and
connecting the first block whose validity has been verified to a block chain,
wherein the verifying of validity of the first block comprises verifying whether the first node is qualified to generate the first block by referring to a header of the first block.

2. The method of claim 1, wherein the header of the first block includes a field indicating at least one of a version of a protocol, a hash value of a header of a parent block, a Merkle root, a time at which the first block has been generated, the degree of difficulty, a nonce value, a node identifier of a node which has generated the first block, proof of the node identifier, and a group count.

3. The method of claim 2, wherein the verifying of validity of the first block comprises verifying validity of each field value included in the header of the first block.

4. The method of claim 2, wherein the verifying of whether the first node is qualified to generate the first block comprises comparing a block turn value determined according to a height of the block chain and a node turn value determined using the node identifier.

5. The method of claim 4, wherein the block turn value is a remainder of dividing the height of the block chain by the group count.

6. The method of claim 4, wherein the node turn value is a remainder obtained by calculating a hash function of the sum of the hash value of the header of the parent block and the node identifier and dividing a result value of the hash function by the group count.

7. The method of claim 3, wherein the verifying of validity of the first block comprises verifying validity of the group count.

8. The method of claim 7, wherein the verifying of validity of the group count comprises:
receiving information of individual nodes according to a communication protocol for identifying the total number of nodes;
determining the total number of nodes by accumulating the received information of the individual nodes; and
determining a group count using the total number of nodes and comparing the determined group count with the group count included in the header of the first block.

9. The method of claim 2, wherein the proof of the node identifier is an electronic signature for the node identifier.

10. The method of claim 2, wherein the verifying of validity of the first block comprises verifying validity of the node identifier using the proof of the node identifier.

11. The method of claim 2, wherein the verifying of validity of the first block comprises verifying validity of the first block using Intel software guard extensions (SGX).

12. A method of generating a block performed by a node in a block chain network, the method comprising:
receiving a first block from a first node;
connecting the received first block to a block chain;
determining whether the current node is qualified to generate a second block, which has the first block connected to the block chain as a parent block;
generating a second block when the current node is qualified to generate a second block; and
transmitting the generated second block to nodes other than the current node.

13. The method of claim 12, wherein the determining of whether the current node is qualified to generate a second block comprises comparing a block turn value determined according to a height of the block chain and a node turn value determined using an identifier of the current node.

14. The method of claim 13, wherein the block turn value is a remainder of dividing the height of the block chain by a group count.

15. The method of claim 13, wherein the node turn value is a remainder obtained by calculating a hash function of the sum of a hash value of a header of the first block and the identifier of the current node and dividing a result value of the hash function by a group count.

16. The method of claim 14, wherein the group count is acquired by determining the total number of nodes in the block chain network and dividing the determined total number of nodes by a preset group size.

17. The method of claim 16, wherein the total number of nodes is determined by receiving information of individual nodes according to a communication protocol for identifying the total number of nodes and accumulating the received information of the individual nodes.

18. The method of claim 13, wherein the generating of the second block comprises generating a header of the second block including a field indicating at least one of the identifier of the current node, a group count, and proof of the identifier of the current node.

19. The method of claim 13, wherein the identifier of the current node is a public key issued from an authentication server.

20. An apparatus for generating a block in a block chain network, the apparatus including at least one processor and a memory configured to store instructions for directing the at least one processor to perform at least one operation, wherein the at least one operation comprises:
receiving a first block from a first node;
connecting the received first block to a block chain;
determining whether a current node is qualified to generate a second block, which has the first block connected to the block chain as a parent block;
generating a second block when the current node is qualified to generate a second block; and
transmitting the generated second block to nodes other than the current node.
